(19) United States
(12) Patent Application Publication
(10) Pub. No.: US 2008/0275202 A1
(43) Pub. Date: Nov. 6, 2008

(54) End-Capped Polymer Chains and Products Thereof

(75) Inventors: Rudolf Faust, Lexington, MA (US); Jae Cheol Cho, Ann Arbor, MI (US)

Correspondence Address: LAHIVE & COCKFIELD, LLP;FLOOR 30, SUITE 3000, ONE POST OFFICE SQUARE, BOSTON, MA, 02109, US

(73) Assignee: UNIVERSITY OF MASSACHUSETTS, Lowell, MA (US)

(21) Appl. No.: 11/794,964

(22) PCT Filed: Jan. 11, 2006
(86) PCT No.: PCT/US2006/001057

§ 371 Date: Apr. 22, 2008

Related U.S. Application Data
(60) Provisional application No. 60/643,326, filed on Jan. 11, 2005.

(51) Int. Cl. C08F 4/10; C08F 226/06; C08F 4/12

(52) U.S. Cl. 526/192; 526/265; 526/226

(57) ABSTRACT

The present invention is directed to copolymers that include a plurality of constitutional units that correspond to cationically polymerizable monomer species and a second polymer block that comprises a plurality of constitutional units that correspond to an anionically polymerizable vinylpyridine, e.g., 2-vinylpyridine, and methods for making the same. Such copolymers can also include a linking moiety, e.g., a Formula (I) group, a Formula (II) group, or any combinations thereof.

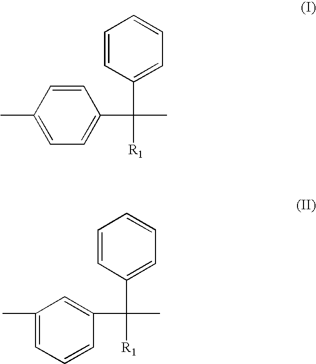

### STATEMENT OF RELATED APPLICATION

This application claims priority to and the benefit of U.S. Provisional Application Ser. No. 60/643,326, filed Jan. 11, 2005, the entire contents of which is incorporated herein by reference. This application is also related to U.S. patent application Ser. No. 10/776,681 filed Feb. 11, 2004, which is incorporated herein by reference in its entirety.

### FIELD OF THE INVENTION

The present invention relates to copolymers including a cationically polymerized polymer coupled to an anionically polymerized polymer, e.g., a vinylpyrimidine species. This invention further relates to processes for end-capping a cationically polymerized polymer with an anionic group, after which the resulting anionically terminated polymer can be used in subsequent anionic reactions, including anionic coupling and polymerization reactions.

### BACKGROUND OF THE INVENTION

Living polymerization (i.e., polymerization proceeding in the practical absence of chain transfer and termination) is a very useful method for designing polymer structures, permitting for example, versatile synthetic routes for the preparation of a wide variety of well-defined polymer structures, such as end-functionalized polymers, star-shaped polymers and/or block copolymers and control of the molecular weight and molecular weight distribution of the polymer, as well as enabling functional groups to be positioned at desired points in the polymer chain. Since Szwarc et al. demonstrated the living nature of polystyryllithium formed from the reaction of sodium naphthalene and styrene in the 1950s, a wide variety of living polymerization schemes have been developed, including cationic, anionic, radical, ring-opening, and group transfer polymerization.

Copolymers are an important class of polymers and have numerous commercial applications. For instance, their unique properties, whether in pure form, in blends, in melts, in solutions, and so forth, lead to their use in a wide range of products, for example, compatiblilizers, adhesives and dispersants. An advantage of combining various polymerization techniques (e.g., cationic and anionic polymerization techniques in the case of the present invention) is that new copolymers, each with its own unique properties, can be prepared which could not otherwise be prepared using a single polymerization method.

For example, polyisoolefins are attractive materials because the polymer chain is fully saturated and, consequently, the thermal and oxidative stability of this polymer are excellent. Polyisoolefins are prepared by cationic polymerization. Recently, Muller et al. reported that poly(alkyl methacrylate)-b-polyisobutylene and poly(alkyl methacrylate)-b-polyisobutylene-b-poly(alkyl methacrylate) copolymers can be prepared by the combination of cationic and anionic polymerization techniques. See Feldthusen, J.; Iván, B.; Müller, A. H. E. Macromolecules, 1997, 30, 6989-6993; Feldthusen, J.; Iván, B.; Müller, A. H. E. Macromolecules 1998, 31, 578-585. In this process, an end-functionalized polyisobutylene (PIB), specifically 1,1-diphenyl-1-methoxy end-functionalized polyisobutylene,

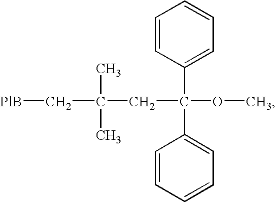

or 2,2-diphenylvinyl end-functionalized polyisobutylene,

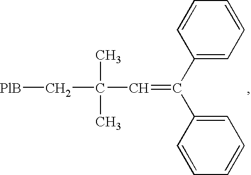

is prepared by the reaction of living polyisobutylene with 1,1-diphenylethylene. The chain end of the resulting polymer is subsequently metallated with alkali metal compounds such as sodium/potassium alloy or cesium in tetrahydrofuran at room temperature. The thus produced macroanion is capable of polymerizing monomer. This method, however, is inconvenient because of the complicated process for the metallation of the polymer chain using alkali metal compounds.

A more recent attempt to combine cationic and anionic polymerization techniques involves the preparation of end-functionalized polymers (e.g., end-functionalized polyisobutylene) by reacting a carbocationically terminated polymer with a heterocyclic compound (e.g., thiophene) to provide an end-capped polymer (e.g., thiophene end-functionalized polyisobutylene). The end-capped polymer is then reacted with an organolithium compound to yield an anionically terminated polymer, which is subsequently reacted with an anionically polymerizable monomer such as tert-butyl methacrylate to produce a copolymer. See, Application Ser. No. 60/480,121 filed Jun. 20, 2003 and entitled “End-Capped Polymer Chains and Products Thereof”, and Martinez-Castro, N,; Lanzendolfer, M. G.; Muller, A. H. E.; Cho, J. C.; Acar, M. H.; and Faust, R. Macromolecules 2003, 36, 6985-6994. An advantage of this process is that simple and complete metallation is achieved. This process, however, is also subject to improvement. For example, in the case where thiophene end-functionalized polyisobutylene is formed, to prevent coupling between thiophene functionalized polyisobutylene and living polyisobutylene, an excess of thiophene is used while functionalizing the polyisobutylene cation with the thiophene. Moreover, the blocking efficiency was found to be only about 80% even when a low molecular weight product is targeted.

### SUMMARY OF THE INVENTION

Because specific living polymerization methods (e.g., anionic and carbocationic living polymerizations) are each applicable only to a limited number of monomers, the combination of different living polymerization techniques should lead to new and unique combinations of blocks in block copolymers.

The present invention is based, at least in part, on the idea that copolymers can be prepared via the combination of living cationic polymerization and living anionic polymerization. Hence, copolymers containing one or more cationically polymerized blocks and one or more anionically polymerized blocks can be formed. Additionally, end-capped polymers formed of cationically polymerizable monomers can be reacted, e.g., quantitatively, with organolithium compounds to form stable anionic macroinitiators, which are then available for numerous anionic polymerization and coupling reactions, including anionically polymerizable vinylpyridines.

Accordingly, in one aspect of the present invention, a novel copolymer is provided, which includes: (a) a first polymer block that comprises a plurality of constitutional units corresponding to a cationically polymerizable monomer species, (b) a second polymer block that comprises a plurality of constitutional units corresponding to an anionically polymerizable vinylpyridine, and (c) at least one linking moiety which links the first and second polymer blocks together. The linking moiety can include a

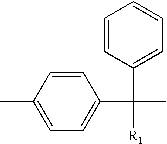

group, a

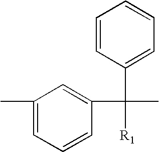

group and/or any combination thereof (for example, a linking moiety selected from a

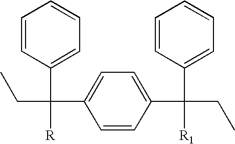

group, a

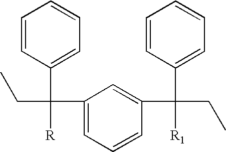

group, and/or combinations thereof), where R is a branched or unbranched alkyl group, typically containing from 1 to 20 carbons, more typically containing from 1 to 10 carbons, and where R₁ is a branched, unbranched, or cyclic alkyl group or an aryl group, also typically containing from 1 to 20 carbons, more typically containing from 1 to 10 carbons. In some embodiments, the anionically polymerizable vinylpyridine is a 2-vinylpyridine.

In other aspects, the present invention relates to novel copolymers that include: (a) a first polymer block that comprises a plurality of constitutional units that correspond to an isobutylene; and (b) a second polymer block that comprises a plurality of constitutional units that correspond to an anionically polymerizable vinylpyridine. In some embodiments, the copolymer also comprises (c) at least one linking moiety linking the first block polymer region with the second block polymer region. The linking moiety can include a

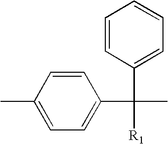

group, a

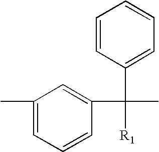

group, and/or any combinations thereof (for example, a linking moiety selected from a

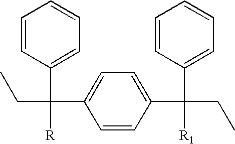

group, a

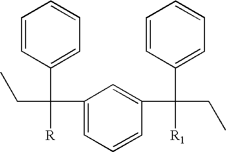

group, and/or combinations thereof), where R₁ is a branched, unbranched, or cyclic alkyl group or an aryl group, containing from 1 to 20 carbons. In some embodiments, the anionically polymerizable vinylpyridine is a 2-vinylpyridine.

In yet another aspect of the present invention, a method is provided in which a double diphenylethylene compound is reacted with a polymer that contains a carbocationically terminated chain, which chain contains a plurality of constitutional units corresponding to cationically polymerizable monomer species, thereby providing a 1,1-diphenylene end-functionalized chain. Subsequently, an alkylating agent is reacted with the 1,1-diphenylene end-functionalized chain, resulting in the formation of an alkylated 1,1-diphenylene end-functionalized chain. The alkylated 1,1-diphenylene end-functionalized polymer is then reacted with an organolithium compound, thus forming an anionically terminated polymer, which is in turn reacted with an anionically polymerizable vinylpyridine.

These and other aspects, embodiments and advantages of the present invention will be more fully understood upon review of the Detailed Description to follow.

### DETAILED DESCRIPTION

Polymers are molecules that contain one or more chains, each containing multiple copies of one or more constitutional units. An example of a common polymer is polystyrene

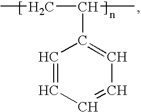

where n is an integer, typically an integer of 10 or more, more typically on the order of 10's, 100's, 1000's or even more, in which the constitutional units in the chain correspond to styrene monomers:

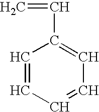

(i.e., they originate from, or have the appearance of originating from, the polymerization of styrene monomers—in this case the addition polymerization of styrene monomers). Copolymers are polymers that contain at least two dissimilar constitutional units.

As used herein a polymer “block” is defined as a grouping of 10 or more constitutional units, commonly 20 or more, 50 or more, 100 or more, 200 or more, 500 or more, or even 1000 or more units, and can be branched or unbranched. A “chain” is a linear (unbranched) grouping of 10 or more constitutional units (i.e., a linear block). In the present invention, the constitutional units within the blocks and chains are not necessarily identical, but are related to one another by the fact that that they are formed in a common polymerization technique, e.g., a cationic polymerization technique or anionic polymerization technique.

In accordance with one aspect of the present invention, copolymers are provided which include (a) one or more blocks which contain a plurality of constitutional units that correspond to one or more cationically polymerizable monomer species and (b) one or more blocks which contain a plurality of constitutional units that correspond to one or more anionically polymerizable monomer species, e.g., one or more anionically polymerizable vinylpyridine. These constitutional units occur within the copolymer molecule at a frequency of at least 10 times, and more typically at least 50, 100, 500, 1000 or more times.

The copolymers of the present invention embrace a variety of configurations, including linear and branched configurations. Branched configurations include star-shaped configurations (e.g., configurations in which three or more chains emanate from a single region), comb configurations (e.g., graft copolymers having a main chain and a plurality of side chains), and dendritic configurations (e.g., arborescent or hyperbranched copolymers).

Some examples of cationically polymerizable monomer species follow: (a) olefins, including isomonoolefins with 4 to 18 carbon atoms per molecule and multiolefins with 4 to 14 carbon atoms per molecule, for example, isobutylene, 2-methylbutene, isoprene, 3-methyl-1-butene, 4-methyl-1-pentene, beta-pinene, and the like, (b) vinyl aromatics such as styrene, alpha-methyl styrene, para-chlorostyrene, para-methylstyrene, and the like, and (c) vinyl ethers such as methyl vinyl ether, isobutyl vinyl ether, butyl vinyl ether, N-vinyl carbazole, and the like.

In certain embodiments, the carbocationically terminated polymer is formed at low temperature (e.g., −80 C) in a reaction mixture that comprises: (a) a solvent system appropriate for cationic polymerization, many of which are well known in the art (for example, a mixture of polar and non-polar solvents, such as a mixture of methyl chloride and hexanes), (b) a monomer (e.g., isobutylene or another cationically polymerizable monomer such as those discussed above), (c) an initiator, for example, tert-ester, tert-ether, tert-hydroxyl or tert-halogen containing compounds, and more typically cumyl esters of hydrocarbon acids such as alkyl cumyl ethers, cumyl halides and cumyl hydroxyl compounds, as well as hindered versions of the same, for instance, tert-butyl dicumyl chloride and tert-butyl dicumyl chloride (5-tert-Butyl-1,3-bis(1-chloro-1-methylethyl)benzene) are used in the Examples below; and (d) a coinitiator, typically a Lewis acid such as boron trichloride or titanium tetrachloride. Carbocationically terminated star polymers can be formed by selecting initiators having three or more initiation sites such as tricumyl chloride (1,3,5-tris(1-chloroy-1-methylethyl)benzene).

In addition, an electron pair donor (e.g., dimethyl acetamide, dimethyl sulfoxide or dimethyl phthalate) or a proton-scavenger (e.g., 2,6-di-tert-butylpyridine, 4-methyl-2,6-di-tert-butylpyridine, 1,8-bis(dimethylamino)-naphthalene or diisopropylethyl amine) can be added to the reaction mixture if desired.

Once a carbocationically terminated polymer is provided in an appropriate solvent system such as those discussed above (e.g., living cationic PIB provided in a CH₃Cl/n-hexane solvent system), a heterocyclic compound like those described above (e.g., thiophene) is added, and allowed to react with the carbocationically terminated polymer under appropriate reaction conditions (e.g., −78 C) to form an end-capped polymer (e.g., PIB-T).

Where a proton scavenger is used (for example, to scavenge protic impurities and thereby achieve a narrowing of the molecular weight distribution of the carbocationically terminated polymer), the amount of proton scavenger is preferably held to a minimum, thereby avoiding reaction of more than one carbocationically terminated polymer with each heterocyclic compound. Preferably, the molar ratio of proton scavenger to carbocationically terminated polymer (which can be approximated by the initial initiator concentration) is 1:1 or less, for example, 0.75:1 or less, 0.66:1 or less, 0.5:1 or less, 0.25:1 or less, or even 0.1:1 or less.

Moreover, the molar ratio of Lewis acid to carbocationically terminated polymer (or initiator) is typically greater than 10, more typically greater than 20, 30, 40 or more in order to improve reactivity with between the polymer and the heterocyclic compound.

In some embodiments, these macroinitiators are used to synthesize star polymers (e.g., PIB stars) by reacting the macroinitiators (e.g., PIB-T⁻,Li⁺) with coupling molecules such as chlorosilanes (which have been used previously to couple living polybutadiene anionic chain ends to form star polymers; see Roovers, J. E. L. and S. Bywater (1972). “Macromolecules 1972, 5, 385).

Examples of anionically polymerizable monomer species include vinyl aromatic monomers such as styrene, styrene derivatives, alkyl substituted styrene and divinyl benzene, diphenylethylene, conjugated dienes such as isoprene and 1,3-butadiene, N,N-disubstituted acrylamides and methacrylamides such as N,N-dimethylacrylamide, acrylates, alkyl acrylates and methacrylates such as isodecyl methacrylate, glycidyl methacrylate and tert-butyl methacrylate, vinyl unsaturated amides, acrylonitrile, methacrylonitrile, vinylpyridine, isopropenyl pyridines, other vinyl monomers such as n-alkyl isocyanates, heterocyclic monomers such as ethylene oxide, ε-caprolactone, L,L-lactide, D,D-lactide, D,L-lactide, and mixtures thereof. Of particular benefit are acrylate or methacrylate monomers having the formula CH₂═CHCO₂R or CH₂═C(CH₃)CO₂R where R is a substituted or unsubstituted, branched, unbranched or cyclic alkyl groups containing 1 to 20 carbons. Substituents for the alkyl groups include hydroxyl, amino and thiol functional groups, among others. In embodiments where monomers are utilized that have functional groups, proper protection of the functional group is commonly needed during the course of anionic polymerization. Specific examples of nonfunctional and protected functional methacrylate monomers include ethyl methacrylate, methyl methacrylate, tert-butyl methacrylate, isodecyl methacrylate, dodecyl methacrylate, stearyl methacrylate, glycidyl methacrylate, 2-[(trimethylsilyl)oxy]ethyl methacrylate, 2-[(tert-butyldimethylsilyl)oxy]ethyl methacrylate, and 2-[(methoxymethyl)oxy]ethyl methacrylate. As used herein, the term “anionically polymerizable vinylpyridine” is meant to include any structure in which a pyridine molecule is substituted with an alkenyl or vinyl group. The pyridine group may be substituted with the vinyl or alkenyl group on any position of the ring. Furthermore, the pyridine or vinyl or alkenyl groups may be further substituted, e.g., with alkyl, alkenyl, hydroxyl, amino, alkoxy, alkylamino or other suitable substituent. Suitable substituents may be chosen, e.g., to alter the three dimensional structure and/or electronic or physical properties of the resulting copolymer. In some embodiments, the anionically polymerizable monomer species is 2-vinylpyridine.

The copolymers of the present invention typically have a molecular weight ranging from 200 to 2,000,000, more typically from 500 to 500,000. The ratio of constitutional units corresponding to the cationically polymerized monomers (e.g., isobutylene) relative to the constitutional units corresponding to the anionically polymerized monomers (e.g., methyl methacrylate) in the copolymer usually ranges from 1/99 to 99/1 w/w, preferably from 30/70 to 95/5 w/w. In some embodiments, copolymers are provided which have a narrow molecular weight distribution such that the ratio of weight average molecular weight to number average molecular weight (Mw/Mn) (i.e., the polydispersity index) of the polymers ranges from about 1 to 10, or even from about 1 to 2.

As a specific example, block copolymers of the formula X(PCA-C-PAN)ₙ are formed in various embodiments of the invention, where X corresponds to the initiator species, C corresponds to the capping species, PCA is a polymer block comprising a plurality of constitutional units that correspond to one or more anionically polymerizable monomer species, for example, a polyolefin block, PAN is a is polymer block comprising a plurality of constitutional units that correspond to one or more anionically polymerizable monomer species, for example, a poly(methyl methacrylate) block, and n is a positive whole number. Linear block copolymers are formed where n=1 or n=2. Where n=2, the copolymers are sometimes referred to as triblock copolymers. This terminology disregards the presence of the initiator fragment, for example, treating PCA-X-PCA as a single olefin block, with the triblock therefore denoted as PCA-PAN-PCA. Star shaped copolymers are formed where n=3 or more. The value of n is typically dictated by the functionality of the initiator molecule, with monofunctional initiators corresponding to n=1, difunctional initiators corresponding to n=2, and so forth.

In accordance with another aspect of the present invention, copolymers are made by a process that includes: (a) providing a 1,1-diphenylene end-functionalized polymer (which polymer contains one or more cationically polymerizable monomer species); and (b) reacting the 1,1-diphenylene end-functionalized polymer with an organometallic compound to yield an anionically terminated polymer (also referred to herein as a “macrocarbanion”, or a “anionic macroinitiator” based on its ability to initiate further reactions such as coupling and polymerization reactions.

For instance, in accordance with an embodiment of the present invention, a living macrocarbocation, e.g., living cationic polyisobutylene, is reacted with a double diphenylethylene, e.g., 1,3-bis(1-phenylethenyl)benzene (sometimes referred to as meta-double diphenylethylene) or 1,4-bis(1-phenylethenyl)benzene (sometimes referred to as para-double diphenylethylene), to produce a 1,1-diphenylethylene end-functionalized carbocationic polymer. The carbocation is then alkylated with a suitable alkylating agent, e.g., with an organometallic compound such as dimethylzinc, whereupon the resulting macromonomer is readily metallated with a suitable organometallic compound such as an alkyllithium compound, thereby providing a living anionic macroinitiator in near quantitative yield. A sterically hindered lithium compound, e.g., a 1,1-diphenylalkyllithium species, is used in certain embodiments to remove impurities that may be present alongside the 1,1-diphenylethylene end-functionalized polymer, thereby preventing premature termination of the living macroanion.

That is, once formed, the end-capped polymer can be isolated and purified. After isolation and purification, the end-capped polymer is lithiated with an organolithium compound, thereby yielding an anionically terminated polymer (or macroinitiator). The organolithium compound is typically an alkyllithium compound, for example, methyllithium, ethyllithium, isopropyllithium, normal-, secondary- and tertiary-butyllithium, benzyllithium, allyllithium, and so forth.

Lithiation can be conducted, for example, at low temperatures (e.g., −40° C.) in a reaction mixture that comprises: (a) a solvent system appropriate for lithiation, many of which are well known in the art (for example, a polar solvent such as THF or a non-polar solvent, such as hexane or toluene in the presence of an electron donor, such as N,N,N′N′-tetramethylethylenedieamine), (b) the end-capped polymer to be lithiated, and (c) the organolithium compound (e.g., an alkyllithium compound such as n-BuLi, s-BuLi or tert-BuLi).

The organolithium compound may be provided in a molar excess relative to the end-capped polymer. For example, the molar ratio of the organolithium compound to the end-capped polymer is beneficially 1.1:1, 1.5:1, 2:1, 4:1, or even greater. Excess organolithium compound can be removed, for example, by increasing the temperature of the same in the presence of a reactive solvent, for example, by increasing the temperature to +30° C. or higher in the presence of THF.

In some embodiments, anionic macroinitiators formed in accordance with the present invention are used to synthesize star polymers (e.g., polyisobutylene stars), for example, by reacting the macroinitiators with coupling molecules such as unhindered chlorosilanes, e.g., SiClₙR₄₋ₙ, or carbosilanes, such as [ClₙSiR₃₋ₙ]₄₋ₘCR′ₘ, or more highly branched structures, where n and m are integers between 1 and 4, R and R′ can independently be either hydrogen or an alkyl group. Chlorosilanes have been used previously to couple living anionic chain ends to form star polymers in Roovers, J. E. L. and S. Bywater, Macromolecules 1972, 5, 385 and in Application Ser. No. 60/480,121 filed Jun. 20, 2003. Other linking agents include aromatic compounds like benzene or naphthalene carrying two or more chloromethyl or bromomethyl or chlorodialkylsilyl groups.

The formation of linear and star polymers is commonly carried out at a temperature that is higher than that of prior steps (e.g., cationic polymerization, end-capping and lithiation), for example, at room temperature (25° C.), or even greater (e.g., 40° C.).

In some embodiments, anionic macroinitiators formed in accordance with the present invention are used to efficiently initiate living polymerization of ionically polymerizable monomer species, e.g., vinylpyridine monomers, yielding block copolymers with high blocking efficiency. The “blocking or crossover efficiency” is the percentage of macroanions that actually initiate polymerization (of vinylpyridine monomers in this instance). The resulting block copolymers, e.g., diblock polymers, triblock copolymers, radial-shaped block copolymers, etc., will exhibit properties that depend upon the cationically and anionically polymerizable species found within the block copolymer, as well as their absolute and relative amounts.

In other embodiments of the invention, block copolymers are reacted (subsequent to anionic polymerization and before anion quenching) with coupling molecules such as (di- or trichloromethyl)benzene or (di- or tribromomethyl)benzene, thereby forming larger-scale copolymers (e.g., PIB-PMMA stars) Application Ser. No. 60/480,121 filed Jun. 20, 2003.

The polymer products of the present invention may be used, for example, as new thermoplastic elastomers, dispersing agents, compatibilizers, emulsifiers, nonionic surfactants or biomaterials.

Further details are provided below.

### Preparation of 1,1-diphenylethylene End-Functionalized Polymers

In accordance with an embodiment of the present invention, 1,1-diphenylethylene end-functionalized polymers are prepared from a living carbocationic polymer. Carbocationically terminated polymers are commonly formed at low temperature from a reaction mixture that comprises: (a) an initiator, (b) a Lewis acid coinitiator, (c) a cationically polymerizable monomer, (c) an optional proton scavenger and (d) an optional diluent.

Suitable initiators include organic ethers, organic esters, and organic halides. Initiators may be monofunctional, difunctional, trifunctional and so forth, thereby producing, for example, diblock copolymers, triblock copolymers, and radial-shaped block copolymers, respectively. Specific examples include tert-alkyl chloride, cumyl ethers, cumyl halides, cumyl esters, and hindered versions of the same, for instance, 2-chloro-2,4,4-trimethylpentane, 5-tert-butyl-1,3-bis(1-chloro-1-methylethyl)benzene, 5-tert-butyl-1,3-bis(1-methoxy-1-methylethyl)benzene, 5-tert-butyl-1,3-bis(1-acetoxy-1-methylethyl)benzene, 1,3,5-tris(1-chloro-1-methylethyl)benzene, 1,3,5-tris(1-methoxy-1-methylethyl)benzene, and 1,3,5-tris(1-acetoxy-1-methylethyl)benzene.

Examples of suitable Lewis acid coinitiators include metal halides and alkyl metal halides such as boron trichloride, titanium tetrachloride and alkyl aluminum halides (e.g., chlorodiethyl aluminum, dichloroethyl aluminum, chlorodimethyl aluminum, dichloromethyl aluminum). A commonly used coinitiator is titanium tetrachloride. The coinitiator is usually used in concentrations equal to or greater than that of initiator, e.g., 1 to 100 times higher, preferably 2 to 40 times higher than that of initiator.

A proton scavenger, typically a Lewis base, typically provided to ensure the virtual absence of protic impurities, such as water, which can lead to polymeric contaminants in the final product. Examples of proton scavengers (also referred to as proton traps) include sterically hindered pyridines, for example, substituted or unsubstituted 2,6-di-tert-butylpyridines, such as 2,6-di-tert-butylpyridine and 4-methyl-2,6-di-tert-butylpyridine, as well as 1,8-bis(dimethylamino)-naphthalene and diisopropylethyl amine. The proton trap is usually used at the concentration of 1 to 10 times higher than that of protic impurities in the polymerization system.

The various reactions of the present invention are typically carried out in the presence of a diluent or a mixture of diluents. For the cationic polymerization and end-capping reactions, typical diluents include (a) halogenated hydrocarbons which contain from 1 to 4 carbon atoms per molecule, such as methyl chloride and methylene dichloride, (b) aliphatic hydrocarbons and cycloaliphatic hydrocarbons which contain from 5 to 8 carbon atoms per molecule, such pentane, hexane, heptane, cyclohexane and methyl cyclohexane, or (c) mixtures thereof. For example, in some embodiments, the solvent system contains a mixture of a polar solvent, such as methyl chloride, methylene chloride and the like, and a nonpolar solvent, such as hexane, cyclohexane or methylcyclohexane and the like.

Regardless of the synthesis technique, once a desired living carbocationically terminated polymer is obtained, it is then available for 1,1-diphenylethylene end-functionalization using a double diphenylethylene species, for example, 1,3-bis(1-phenylethenyl)benzene,

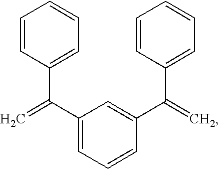

or 1,4-bis(1-phenylethenyl)benzene,

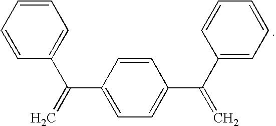

The 1,4-bis(1-phenylethenyl)benzene is typically more beneficial than the 1,3-bis(1-phenylethenyl)benzene for the functionalization of both living anionic and cationic polymers, because a coupled product is typically not generated where the 1,4-bis(1-phenylethenyl)benzene is employed. In the present invention, double diphenylethylene is typically employed at a concentration that is 1 to 10 times higher than that of the initiator, more typically 1 to 6 times higher than that of the initiator. In this regard, it is known that 1,1-diphenylethylene end-functionalized polyisobutylene can be prepared by the reaction of a living cationic polymer such as polyisobutylene with 1,3-bis(1-phenylethenyl)benzene or 1,4-bis(1-phenylethenyl)benzene. See Bae, Y. C.; Faust, R. Macromolecules 1998, 31(26), 9379-9383. Unfortunately, the quenching reaction of a living diphenyl carbenium ion (e.g., a polymer end-functionalized with 1,1-diphenylethylene carbocation) with methanol introduces a labile methoxy group at the chain end, which will lead to side reactions. Side reactions include the termination of subsequently added organolithium compounds as well as the macroinitiators that are formed from the subsequently added organolithium compounds.

To prevent this, in various embodiments of the present invention, the 1,1-diphenylethylene carbocation is subjected to an alkylation reaction. In general, the alkylation is carried out with an organometallic compound, such as an alkyl aluminum compound and an alkyl zinc compound which typically contains from 1 to 20 carbon atoms, for example, selected from various branched or unbranched alkyl groups. In the present invention, the alkyl aluminum or alkyl zinc compound is typically used at a concentration ranging from 0.1 to 100 times the coinitiator concentration, more typically 0.1 to 10 times the coinitiator concentration.

Bae, Y. C.; Kim, I-J.; Faust, R. Polymer Bulletin 2000, 44(5-6), 453-459, has reported the methylation of

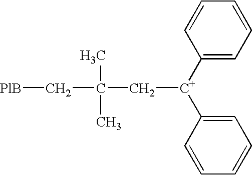

with dimethylzinc to form

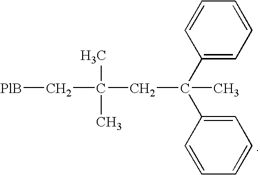

Temperatures for the polymerization of the cationically polymerizable monomer, as well as the subsequent end-functionalization and alkylation of the resulting living polymer, will typically range from 0° C. to −150° C., more typically from −10° C. to −90° C. Reaction time for the cationic polymerization and the functionalization and alkylation of the resulting living cationic polymer will typically range from a few minutes to 24 hours, more typically from 10 minutes to 10 hours.

The number average molecular weight of the resulting 1,1-diphenylethylene end-functionalized polymer will typically range from 1,000 to 1,000,000, more typically from 5,000 to 500,000.

A specific example of a procedure for the preparation of 1,1-diphenylethylene end-functionalized polymers follows. First, a living carbocationically terminated polymer, e.g., carbocationically terminated polyisobutylene, is obtained by adding a coinitiator into a polymerization zone (e.g., a flask), which contains initiator, proton trap, monomer and diluent as discussed above. After polymerization of the monomer is complete, the resulting living cationic polymer, in this instance, living carbocationically terminated polyisobutylene (PIB),

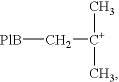

is reacted with a double diphenylethylene species, in this example 1,4-bis(1-phenylethenyl)benzene,

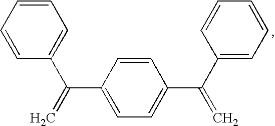

for example, by dissolving the double diphenylethylene species in a diluent and charging it to the polymerization zone, whereupon a carbenium cation, e.g.,

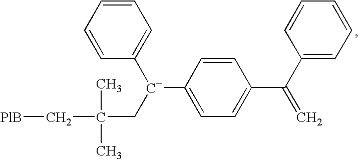

is formed. An alkyl zinc or alkyl aluminum compound, e.g., dimethylzinc (CH₃)₂Zn, is then supplied to alkylate the carbinium ion, for example, by dissolving it in a diluent and charging the resulting solution to the polymerization zone. Prechilled alcohol is then charged to the polymerization zone to quench the reaction. The resulting 1,1-diphenylethylene end-functionalized polymer product, e.g.,

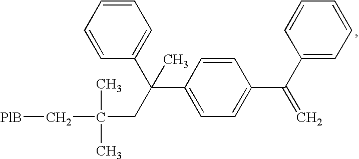

is then recovered.

### Preparation of Block Copolymer Using 1,1-Diphenylethylene End-Functionalized Macromer

Once a 1,1-diphenylethylene end-functionalized macromer is provided, it is readily metallated with an organometallic compound, and the resulting anionic macroinitiator is then available for a variety of reactions, including the living anionic polymerization reactions and anionic coupling reactions.

Organometallic compounds suitable for the metallation of the 1,1-diphenylethylene end-functionalized macromer can be selected, for example, from a wide range of organolithium compounds of the formula RLi in which R is a hydrocarbon group, typically containing from 1 to 20 carbon atoms per molecule, for example, selected from unbranched alkyl groups, branched alkyl groups, cyclic alkyl groups, mono-ring aryl groups and multi-ring aryl groups. Specific examples of suitable organolithium compounds include methyllithium, ethyllithium, isopropyllithium, n-butyllithium, sec-butyllithium, tert-butyllithium, tert-octyllithium, phenyllithium, 1-naphthyllithium, p-tolyllithium, cyclohexyllithium, and 4-cyclohexylbutyllithium. Organolithium compounds are typically used at concentrations that are 1 to 50 times the 1,1-diphenylethylene end-functionalized macromer concentration, more typically 1 to 10 times the macromonomer concentration.

The metallation, as well as subsequent living anionic polymerization and coupling processes, are typically carried out in the presence of a diluent or mixture of diluents. Suitable diluents include hydrocarbon solvents, for example, paraffinic, cycloparaffinic, and aromatic hydrocarbon solvents, and polar solvents, for example, ethers such as tetrahydrofuran, dimethylether, diethylether, dioxane, and 1,2-dimethoxyethane.

Reaction times between the organolithium compound and the 1,1-diphenylethylene end-functional polymer will typically range from a few minutes to 24 hours, more typically from 1 hour to 12 hours. Temperatures for the reaction between the organolithium compound and the 1,1-diphenylethylene end-functional polymer will typically range from 30° C. to −100° C., more typically from 30° C. to −90° C.

In some embodiments, a small amount of a sterically hindered lithium compound is charged to the polymerization zone prior to introducing the alkyllithium compound to remove impurities that are frequently present, thereby preventing termination during the reaction of the alkyllithium compound with the 1,1-diphenyethylene end-functionalized polymer. Because the 1,1-diphenylalkyllithium cannot react with 1,1-diphenylethylene end-functionalized polymer due to steric effects, its addition is effective for purposes of removing impurities that are present in the solution.

Examples of sterically hindered organolithium compounds include organolithium compounds of the formula RC(Ø₁)(Ø₂)Li in which R is a hydrocarbon group, typically containing 1 to 20 carbon atoms per molecule, including unbranched alkyl groups, branched alkyl groups, cyclic alkyl groups, mono-ring aryl groups, and multi-ring aryl groups, and Ø₁ and Ø₂ can be the same or different and are selected from unsubstituted or substituted, mono- or multi-ring, aryl groups. Commonly, the sterically hindered organolithium compound is a 1,1-diphenylalkyllithium compound.

1,1-Diphenylalkyllithium may be generated, for example, from the reaction of an alkyllithium compound and 1,1-diphenylethylene at room temperature in the presence of diluent. 1,1-Diphenylethylene is typically used in concentrations equal to or less than that of the alkyllithium in this reaction. A example of one beneficial 1,1-diphenylalkyllithium compound is 1 1,1-diphenylhexyllithium,

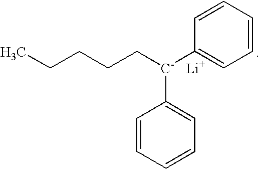

The sterically hindered organolithium compound is typically added to a solution containing the 1,1-diphenylethylene end-functional polymer and a diluent or mixture of diluents, for example, at room temperature. Afterwards, the organolithium compound is added to the 1,1-diphenylethylene functional polymer, for instance, under anionic reaction conditions (e.g., at −78° C.). After a stable living macroinitiator is formed in this fashion, any unreacted alkyllithium may be destroyed by heating, for example, to 40° C. in the presence of a reactive species such as tetrahydrofuran (which can also be used as a diluent).

The resulting anionic macroinitiator is then available for subsequent polymerization or coupling reactions, as desired. For example, in some embodiments, an anionically reactive species such as an anionically polymerizable monomer are added under polymerization conditions (e.g., at −78° C.) to the macroinitiator. After the desired reaction is completed, purified alcohol is typically charged to the polymerization zone to quench the reaction.

Times for anionic polymerization will typically range from a few minutes to 24 hours, more typically from 5 minutes to 12 hours. Temperatures for anionic polymerization will typically range from 0° C. to −100° C., more typically from −10° C. to −90° C.

As a specific example, the reaction of a 1,1-diphenylethylene end-functionalized macromer, for example, 1,1-diphenylethylene end-functionalized polyisobutylene (see above), with an organolithium compound, for example, n-butyl lithium, results in the formation of a carbanion, e.g.,

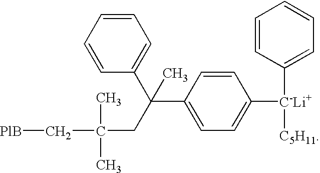

Subsequent exposure of the carbanion to an anionically polymerizable monomer, e.g., a methacrylate monomer such as methyl methacrylate (MMA), results in a copolymer having (a) a cationically polymerized block, for example, a polyisobutylene block, and (b) an anionically polymerized block, for example, a poly(methyl methacrylate) (PMMA) block:

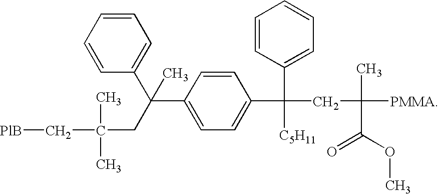

As another example, an exemplary carbanion, e.g.,

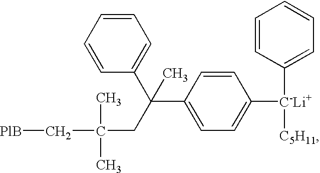

may be exposed to, e.g., 2-vinylpyridine, thus resulting in a copolymer having (a) a cationically polymerized block, for example, a polyisobutylene block, and (b) an anionically polymerized block, for example, a polyvinylpyridine (PVPy) block:

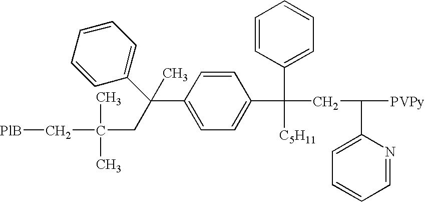

### EXAMPLES

Characterizations. ¹H-NMR spectroscopy was carried out on a Bruker AC 250 MHz spectrometer at 25° C. in CDCl₃. Gel Permeation Chromatorgraphy (GPC) was carried out using a Waters HPLC system equipped with model 510 HPLC pump, model 410 differential refractometer, model 486 UV/visible detector, model 712 sample processor, and five ultra-Styragel columns connected in the series (500, 10³, 10⁴, 10⁵ and 100 Å). THF was used as an eluent at a flow rate of 1 mL/min.

Materials. 2,6-Di-tert-butylpyridine (Aldrich, 97%) was purified by distillation from CaH₂. Isobutylene (Air Gas) was passed through in-line gas purifier columns packed with CaSO₄ and no. 13 molecular sieves and condensed at −15° C. prior to polymerization. Methyl chloride (CH₃Cl) was passed through in-line gas purifier columns packed with BaO/Drierite and condensed at −80° C. prior to polymerization. Methylene chloride (CH₂Cl₂) was purified by washing it with 10% aqueous NaOH and then with distilled water until neutral and dried over anhydrous MgSO₄ overnight. It was refluxed for 24 h and distilled from CaH₂, just before use. n-Hexane was rendered olefin free by refluxing it over concentrated sulfuric acid for 48 h. It was washed with 10% aqueous NaOH and then with deionized water until neutral and stored over MgSO₄ for 24 h. It was refluxed over CaH₂ overnight and distilled. Titanium (IV) chloride (TiCl₄, Aldrich, 99.9%) was used as received. 2-Chloro-2,4,4-trimethylpentane was prepared by hydrochlorination of 2,4,4-trimethyl-1-pentene (Fluka, 98%) with hydrogen chloride gas in dry dichloromethane at 0° C. Kaszas, G.; Gyor, M.; Kennedy, J. P.; Tüdös, F. J. Macromol. Sci., Chem 1983, A18, 1367-1382. The product was dried over CaCl₂ and distilled under reduced pressure before use. 5-tert-butyl-1,3-bis(1-chloro-1-methylethyl)benzene was synthesized following the procedure reported in Gyor, M. Wang., H. C.; Faust, R. J. J. Macromol. Sci., Pure Appl. Chem. 1992, A29, 639. Tetrahydrofuran (Merck p.a) was purified first by distillation under nitrogen from CaH₂ and then by refluxing over potassium. n-Butyllithium (n-BuLi, 2.5 M in hexane) was purchased from Aldrich and its concentration was titrated by a standard method. See, e.g., Reed, P. J.; Urwin, J. R. J. Organometal. Chem. 1972, 39, 1-10. Methyl methacrylate (MMA) and 2-[(trimethylsilyl)oxy]ethyl methacrylate (TMSiOEMA), in which the hydroxyl group of 2-hydroxyethyl methacrylate (HEMA) is protected with a trimethylsilyl group, were dried over CaH₂ for 24 h and then distilled over triethylaluminum or trioctylaluminum under vacuum. The 1,4-Bis(1-phenylethenyl)benzene is synthesized using known procedures, e.g., those described in U.S. Pat. No. 4,182,818 to Tung, L. H. and Lo, G. Y.-S. 1,1-Diphenylethylene purchased from Aldrich Chemical Company was purified by vacuum distillatin under potassium metal.

Synthesis of 1,1-diphenyhexyllithium. The preparation of 1,1-diphenylhexyllithium is carried out under high vacuum conditions (<10⁻⁶ mbar). 0.037 g of n-butyllithium (5.7×10⁻⁴ mol) is added at −78° C. to a reactor containing 0.01 mL of 1,1-diphenylethylene (5.7×10⁻⁵ mol) dissolved in tetrahydrofuran. After 5 minutes, the cherry-reddish solution is brought to room temperature for 1 hour. During this step, unreacted n-butyllithium is decomposed by the reaction with tetrahydrofuran. The solution is delivered into a graduated cylinder with a stopcock, which is stored in a refrigerator.

Synthesis of α,ω-1,1-diphenylethylene end-functionalized polyisobutylene. The preparation of a difunctional macromonomer is carried out at −80° C. under nitrogen atmosphere. To a prechilled 500 mL 3-neck flask equipped with mechanical stirrer are added sequentially 187 mL of hexane, 111 mL of methyl chloride, 0.086 g of 5-tert-butyl-1,3-bis(1-chloro-1-methylethyl)benzene (3.0×10⁻⁴ mol), 0.2 mL of 2,6-di-tert-butylpyridine (9.0×10⁻⁴ mol), and 21 mL of isobutylene (0.27 mol). Then, 1.2 mL of titanium tetrachloride (1.1×10⁻² mol) is added into the reactor to polymerize the isobutylene. After the completion of monomer polymerization, 0.34 g of 1,4-bis(1-phenylethenyl)benzene (1.2×10⁻³ mol) dissolved in methylene chloride is added into the reactor. After 2 hours, 5.15 g of dimethylzinc (5.4×10⁻² mol) dissolved in toluene is added into the reactor. 2 hours later, 30 mL of prechilled methanol is added into the reactor to quench the reaction. The polymer solution is then poured into ammonium hydroxide/methanol (10/90, v/v). After the evaporation of solvents, the polymer is dissolved in hexane and inorganics are filtered. The polymer recovered by the precipitation of the polymer solution into methanol. The polymer is then dissolved again in hexane and recovered again by the precipitation of the polymer solution into methanol, followed by drying in a vacuum.

According to ¹H NMR and GPC measurements, functionalization and methylation at polyisobutylene chain ends are essentially complete. Essentially no change in the number average molecular weight and polydispersity of the 1,1-diphenylethylene functional polyisobutylene was observed, relative to those of the polyisobutylene precursor (Table 1), confirming that coupling reactions are virtually nonexistant.

TABLE 1

| Polymer | Mₙ | M_{w}/Mₙ |
|---|---|---|
| Polyisobutylene | 55000 | 1.03 |
| α,ω-1,1-Diphenylethylene | 56800 | 1.04 |
| end-functional polyisobutylene | | |

Synthesis of ω-1,1-diphenylethylene end-functionalized polyisobutylene. The preparation of monofunctional macromonomer is carried out at −80° C. under nitrogen atmosphere. To a prechilled 500 mL flask equipped with mechanical stirrer are added sequentially 198 mL of hexane, 118 mL of methyl chloride, 0.1 mL of 2-chloro-2,4,4-trimethylpentane (6.0×10⁻⁴ mol), 0.2 mL of 2,6-di-tert-butylpyridine (9.0×10⁻⁴ mol), and 4.7 mL of isobutylene (0.06 mol). 1.2 mL of titanium tetrachloride (1.1×10⁻² mol) is then added into the reactor to polymerize the isobutylene. After the completion of monomer polymerization, 0.34 g of 1,4-bis(1-phenylethenyl)benzene (1.2×10⁻³ mol) dissolved in methylene chloride is added into the reactor. After 2 hours, 5.15 g of dimethylzinc (5.4×10⁻² mol) is added into the reactor. After 2 more hours, 30 mL of prechilled methanol is added into the reactor to quench the reaction. The polymer solution is then poured into ammonium hydroxide/methanol (10/90, v/v). After the evaporation of solvents, the polymer is dissolved in hexane and inorganics are filtered. The polymer solution is then precipitated into methanol to give solid polymer. The solid polymer is again dissolved in hexane and recovered again by the precipitation of the polymer solution into methanol, followed by drying under vacuum.

According to ¹H NMR and GPC measurements, functionalization and methylation at the polyisobutylene chain end are essentially complete. Number average molecular weight and polydispersity of 1,1-diphenylethylene functional polyisobutylene did not change substantially as compared with those of polyisobutylene (Table 2), confirming a virtual absence of coupling reactions.

TABLE 2

| Polymer | Mₙ | M_{w}/Mₙ |
|---|---|---|
| Polyisobutylene | 4500 | 1.09 |
| ω-1,1-Diphenylethylene end- | 4900 | 1.08 |
| functional polyisobutylene | | |

### Example 1

All chemical purifications and acrylate polymerizations are carried out under high vacuum condition (<10⁻⁶ mbar). 1.17 g (2.06×10⁻⁵ mol) of α,ω-1,1-diphenylethylene end-functionalized polyisobutylene (Mₙ=56800, see above) in 250 mL of hexane is stirred over calcium hydride for 24 hours. The polymer solution is then filtered to remove calcium hydride. The hexane solvent is evaporated, and 100 mL of tetrahydrofuran are added to the remaining polymer. This polymer solution is then added to a reactor equipped with a stirrer. 1,1-diphenylhexyllithium in tetrahydrofuran (see above) is added into the reactor dropwise until the color of the polymer solution changes from colorless to yellowish. The amount of 1,1-diphenylhexyllithium used for this purpose is 0.0010 g (4.1×10⁻⁶ mol). The polymer solution is subsequently cooled down to −78° C. with vigorous stirring. After 10 minutes at this temperature, 0.0090 g of n-butyllithium (1.4×10⁻⁴ mol) in 27.5 mL of hexane is added into the reactor. 12 hours later, the polymer solution is heated up to 40° C. and kept at this temperature for 1 hour. The polymer solution is again cooled to −78° C. After 10 minutes at this temperature, 0.95 mL of methyl methacrylate (8.9×10⁻³ mol) is distilled into the reactor. The reactoin is quenched after 5 hours by adding purified degassed methanol to the reactor. The polymer solution is precipiated into methanol to give a white solid polymer.

The blocking efficiency of the obtained block copolymer is measured using GPC and ¹H NMR and is calculated to be at least 87%. The product is immersed into hexane for 24 hours to isolate polyisobutylene homopolymer from the block copolymer. According to ¹H NMR and GPC measurements, the purified block copolymer has a Mₙ=109400, a M_{w}/Mₙ=1.14, and the composition of isobutylene and methyl methacrylate in the polymer is 57/43 w/w.

### Example 2

1.60 g (2.8×10⁻⁵ mol) of α,ω-1,1-diphenylethylene end-functionalized polyisobutylene (Mₙ=56800, see above) in 200 mL of hexane is stirred over calcium hydride for 24 hours. The polymer solution is then filtered to remove calcium hydride. Solvent is evaporated, and 100 mL of tetrahydrofuran is added to the remaining polymer. The polymer solution is then added to a reactor equipped with a stirrer, and 1,1-diphenylhexyllithium in tetrahydrofuran (see above) is added into reactor dropwise until the color of the polymer solution changes from colorless to yellowish. The amount of 1,1-diphenylhexyllithium used for this purpose is 0.0010 g (4.1×10⁻⁶ mol). The polymer solution is subsequently cooled to −78° C. with vigorous stirring. After 10 minutes at this temperature, 0.0122 g of n-butyllithium (1.9×10⁻⁴ mol) in 40 mL of hexane is added into the reactor. After an additional 12 hours, the polymer solution is heated to 40° C. and kept at this temperature for 1 hour. The polymer solution is then cooled down to −78° C. After 10 minutes at this temperature, 0.64 mL of methyl methacrylate (6.0×10⁻³ mol) is distilled into the reactor. 5 hours later, purified methanol is added to reactor to quench the reaction. The polymer solution is poured into methanol to yield a white solid polymer.

The blocking efficiency of the obtained block copolymer is measured using GPC and ¹H NMR and is calculated to be at least 92%. The block copolymer is purified by using hexane to remove polyisobutylene homopolymer. According to ¹H NMR and GPC measurements, the purified block copolymer had a Mₙ=83400, a M_{w}/Mₙ=1.30, and the composition of isobutylene and methyl methacrylate in the polymer is 67/33 w/w.

### Example 3

1.96 g (3.45×10⁻⁵ mol) of α,ω-1,1-diphenylethylene end-functionalized polyisobutylene (Mₙ=56800, see above) in 300 mL of hexane is stirred over calcium hydride for 24 hours. The polymer solution is then filtered to remove calcium hydride. The solvent is evaporated and 130 mL of tetrahydrofuran are added to the remaining polymer. The resulting polymer solution is then added to a reactor equipped with a stirrer. 1,1-diphenylhexyllithium in tetrahydrofuran (see above) is then added into reactor dropwise until the color of the polymer solution changes from colorless to yellowish. The amount of 1,1-diphenylhexyllithium used for this purpose is 0.0030 g (1.2×10⁻⁵ mol). Afterwards, the polymer solution is cooled down to −78° C. with vigorous stirring. After 10 minutes at this temperature, 0.0160 g of n-butyllithium (2.5×10⁻⁴ mol) in 40 mL of hexane is added into the reactor. 2 hours later, the polymer solution is heated to 40° C. and kept at this temperature for 1 hour. Then, the polymer solution is again cooled to −78° C. After 10 minutes at this temperature, 2 mL of 2-[(trimethylsilyl)oxy]ethyl methacrylate (9.2×10⁻³ mol) diluted with 2 mL of tetrahydrofuran is added into the reactor. 3 hours later, purified methanol is added to reactor to quench the reaction. The polymer solution is precipitated into methanol to yield a white solid polymer.

The blocking efficiency is at least 90%, as measured using GPC and ¹H NMR. The obtained polymer is purified by using hexane to remove polyisobutylene homopolymer. During the recovery step, the trimethylsilyloxy groups in the block copolymer are completely converted into hydroxyl groups. For ¹H NMR and GPC measurements, the block copolymer is treated with benzoic anhydride to protect the hydroxyl groups in the poly(2-hydroxylethyl methacrylate) blocks with a benzoyl group. According to ¹H NMR and GPC measurements, the block copolymer treated with benzoic anhydride had a Mₙ=131900, a M_{w}/Mₙ=1.33, and the composition of isobutylene and 2-hydroxylethyl methacrylate in the polymer is 50/50 w/w.

### Example 4

0.93 g (1.9×10⁻⁴ mol) of ω-1,1-diphenylethylene end-functionalized polyisobutylene (Mₙ=4900, see above) in 200 mL of hexane is stirred over calcium hydride for 24 hours. Then, the polymer solution is filtered to remove calcium hydride. Solvent is evaporated, and 100 mL of tetrahydrofuran is added to the remaining polymer. The polymer solution is added to a reactor equipped with a stirrer. Unlike the above examples, no 1,1-diphenylhexyllithium in tetrahydrofuran is then added to the reactor at this point. The polymer solution is cooled down to −78° C. with vigorous stirring. After 10 minutes at this temperature, 0.0961 g of n-butyllithium (1.5×10⁻³ mol) is added into the reactor. 1 hour later, the polymer solution is heated to 20° C. and kept at this temperature for 1 hour. Then, the polymer solution is again cooled to −78° C. After 10 minutes at this temperature, 1.5 mL of methyl methacrylate (1.4×10⁻² mol) is charged into the reactor. 2 hours later, purified methanol is added to reactor to quench the reaction. The polymer solution is then poured into methanol to yield a white solid polymer.

The blocking efficiency is calculated to be 67% based on GPC and ¹H NMR results. The obtained polymer is purified using hexane to remove polyisobutylene homopolymer. According to ¹H NMR and GPC measurements, the purified block copolymer has a Mₙ=22300, a M_{w}/Mₙ=1.26, and the composition of isobutylene and methyl methacrylate in the polymer is 25/75 w/w.

### Example 5

0.24 g of ω-1,1-diphenylethylene end-functionalized polyisobutylene (Mₙ=4900, see above) in 200 mL of hexane is stirred over calcium hydride for 24 hours. Then, the polymer solution is filtered to remove calcium hydride. Solvent is evaporated and 100 mL of tetrahydrofuran is then added to the remaining polymer. The polymer solution is added to a reactor equipped with a stirrer. No 1,1-diphenylhexyllithium in tetrahydrofuran is added to the reactor at this point. The polymer solution is then cooled down to −78° C. with vigorous stirring. After 10 minutes, 0.0275 g of n-butyllithium (4.3×10⁻⁴ mol) is added into the reactor. 1 hour later, the polymer solution is heated up to 20° C. and kept at this temperature for 1 hour. The polymer solution is then cooled down to −78° C. After 10 minutes at this temperature, 0.6 mL of methyl methacrylate (5.6×10⁻³ mol) is distilled into the reactor. 2 hours later, purified methanol is added to reactor to quench the reaction. The polymer solution is then poured into methanol to yield a white solid polymer.

The blocking efficiency is calculated to be 72% based on GPC and ¹H NMR results. The obtained polymer is purified using hexane to remove polyisobutylene homopolymer. According to ¹H NMR and GPC measurements, the purified block copolymer had a Mₙ=31700, a M_{w}/Mₙ=1.13, and the composition of isobutylene and methyl methacrylate in the polymer is 18/82 w/w.

### Example 6

0.14 g of ω-1,1-diphenylethylene end-functionalized polyisobutylene (Mₙ=4900, see above) in 200 mL of hexane is stirred over calcium hydride for at least 24 hours. The polymer solution is then filtered to remove calcium hydride. Solvent is evaporated and 100 mL of tetrahydrofuran is added to polymer. The polymer solution is added to a reactor equipped with a stirrer. No 1,1-diphenylhexyllithium in tetrahydrofuran is added to the reactor at this point. The polymer solution is then cooled down to −78° C. with vigorous stirring. After 10 minutes at this temperature, 0.016 g of n-butyllithium (2.5×10⁻⁴ mol) is added into the reactor. 1 hour later, the polymer solution is heated up to 20° C. and kept for 1 hour at this temperature. The polymer solution is again cooled down to −78° C. After 10 minutes at this temperature, 0.4 mL of methyl methacrylate (3.7×10⁻³ mol) is charged into the reactor. 2 hours later, purified methanol is added to reactor to quench the reaction. The polymer solution is then poured into methanol to yield a white solid polymer.

The blocking efficiency is calculated to be 68%, based on GPC and ¹H NMR results. The obtained polymer is purified by using hexane to remove polyisobutylene homopolymer. According to ¹H NMR and GPC measurements, the purified block copolymer has a Mₙ=36900, an M_{w}/Mₙ=1.20, and the composition of isobutylene and methyl methacrylate in the polymer is 15/85 w/w.

### Example 7

All chemical purifications and anionic polymerizations are carried out under high vacuum condition (<10⁻⁶ mbar).

1.50 g (2.6×10⁻⁵ mol) of α,ω-1,1-diphenylethylene end-functionalized polyisobutylene (Mₙ=56800, see above) in 200 mL of hexane is stirred over calcium hydride for 24 hours. The polymer solution is then filtered to remove calcium hydride. Solvent is evaporated, and 87 mL of tetrahydrofuran is added to the remaining polymer. The polymer solution is then added to a reactor equipped with a stirrer, and 1,1-diphenylhexyllithium in tetrahydrofuran (see above) is added into reactor dropwise until the color of the polymer solution changes from colorless to yellowish. The amount of 1,1-diphenylhexyllithium used for this purpose is 0.0010 g (4.1×10⁻⁶ mol). The polymer solution is subsequently cooled to −78° C. with vigorous stirring. After 10 minutes at this temperature, 0.01 g of n-butyllithium (1.6×10⁻⁴ mol) in 33 mL of hexane is added into the reactor. After an additional 12 hours, the polymer solution is heated to 40° C. and kept at this temperature for 1 hour. The polymer solution is then cooled down to −78° C. After 10 minutes at this temperature, 1.19 mL 2-vinylpyridine (1.1×10⁻² mol) is distilled into the reactor. 40 minutes later, purified methanol is added to reactor to quench the reaction. The polymer solution is poured into methanol to yield a white solid polymer.

The block copolymer is purified by using hexane to remove polyisobutylene homopolymer. According to GPC and ¹H NMR measurements, the purified block copolymer had an apparent Mₙ=67000, a M_{w}/Mₙ=1.11, and the composition of isobutylene and 2-vinylpyridine in the polymer is 68/32 w/w.

Although various embodiments are specifically illustrated and described herein, it will be appreciated that modifications and variations of the present invention are covered by the above teachings and are within the purview of the appended claims without departing from the spirit and intended scope of the invention.

1. A copolymer comprising:
(a) a first polymer block that comprises a plurality of constitutional units that correspond to a cationically polymerizable monomer species,
(b) a second polymer block that comprises a plurality of constitutional units that correspond to an anionically polymerizable vinylpyridine, and
(c) at least one linking moiety linking said first block polymer region with said second block polymer region, wherein the linking moiety is at least one moiety selected from the group consisting of a 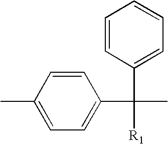
group, a 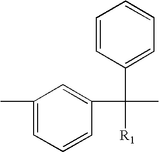
group, and combinations thereof, where R₁ is a branched, unbranched, or cyclic alkyl group or an aryl group, containing from 1 to 20 carbons.

2. The copolymer of claim 1, wherein the linking moiety comprises at least one moiety selected from the group consisting of a 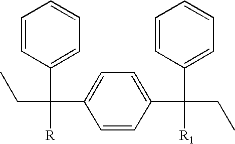
group, a 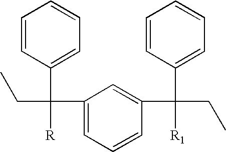
group, and combinations thereof, where R is a branched or unbranched alkyl group containing from 1 to 20 carbons, and where R₁ is a branched, unbranched, or cyclic alkyl group or an aryl group, containing from 1 to 20 carbons.

3. The copolymer of claim 2, wherein R is methyl or ethyl, and R₁ is n-pentyl or 2-methyl-butyl.

4. The copolymer of claim 1, wherein the number average molecular weight of the polymer ranges from 10,000 to 1,000,000.

5. The copolymer of claim 1, wherein the anionically polymerizable vinylpyridine is 2-vinylpyridine.

6. The copolymer of claim 1, wherein the first polymer block comprises a plurality of constitutional units that correspond to two or more differing cationically polymerizable monomer species.

7. The copolymer of claim 1, wherein the first polymer block comprises a plurality of constitutional units that correspond to an isobutylene.

8. The copolymer of claim 1, wherein the second polymer block further comprises a plurality of constitutional units that correspond to an anionically polymerizable monomer species.

9. The copolymer of claim 1, wherein the polymer comprises two or more of said second polymer blocks and two or more of said linking moieties.

10. The copolymer of claim 1, wherein the copolymer is a linear copolymer.

11. The copolymer of claim 1, wherein the copolymer is a radial-shaped copolymer.

12. A method comprising:
(a) contacting under reaction conditions a double diphenylethylene compound with a polymer that comprises a carbocationically terminated chain, said chain further comprising a plurality of constitutional units that correspond to cationically polymerizable monomer species, thereby providing a 1,1-diphenylene end-functionalized chain;
(b) contacting under reaction conditions the 1,1-diphenylene end-functionalized chain with an alkylating agent, thereby providing an alkylated 1,1-diphenylene end-functionalized chain;
(c) contacting, under reaction conditions, an organolithium compound with the alkylated 1,1-diphenylene end-functionalized polymer, thereby providing an anionically terminated polymer; and
(d) contacting under reaction conditions the anionically terminated polymer with an anionically polymerizable vinylpyridine.

13. The method of claim 12, wherein the alkylating agent is an alkylaluminum compound or an alkylzinc compound.

14. The method of claim 12, wherein the alkylating agent is dimethyl-zinc.

15. The method of claim 12, wherein the double diphenylethylene compound is 1,4-bis(1-phenylethenyl)benzene.

16. The method of claim 12, wherein the organolithium compound is of the formula RLi in which R is a hydrocarbon group containing from 1 to 20 carbon atoms per molecule selected from alkyl groups, aryl groups, and alky-aryl groups.

17. The method of claim 12, wherein the organolithium compound is selected from methyllithium, ethyllithium, isopropyllithium, n-butyllithium, sec-butyllithium, tert-butyllithium, tert-octyllithium, phenyllithium, 1-naphthyllithium, p-tolyllithium, cyclohexyllithium, and 4-cyclohexylbutyllithium.

18. The method of claim 12, further comprising combining a 1,1-diphenylorganolithium compound with the alkylated 1,1-diphenylene end-functionalized polymer prior to contact with the organolithium compound.

19. The method of claim 18, wherein the 1,1-diphenylorganolithium compound is of the formula RC(Ø)₂Li in which R is a hydrocarbon group containing 1 to 20 carbon atoms per molecule and Ø is an unsubstituted or substituted aryl group.

20. The method of claim 12, wherein the 1,1-diphenylorganolithium compound is 1,1-diphenylhexyllithium or 1,1-diphenyl-4-methylpentyllithium.

21. The method of claim 12, wherein the anionically polymerizable vinylpyridine is a 2-vinylpyridine.

22. The method of claim 12, wherein the cationically polymerizable monomer species is an isoolefin monomer species.

23. A copolymer comprising:
(a) a first polymer block that comprises a plurality of constitutional units that correspond to an isobutylene; and
(b) a second polymer block that comprises a plurality of constitutional units that correspond to an anionically polymerizable vinylpyridine.

24. The copolymer of claim 23, further comprising
(c) at least one linking moiety linking the first block polymer region with the second block polymer region, wherein the linking moiety is at least one moiety selected from the group consisting of a 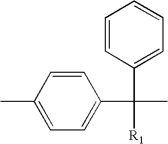
group and a 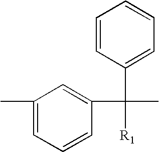
group, where R₁ is a branched, unbranched, or cyclic alkyl group or an aryl group, containing from 1 to 20 carbons.

25. The copolymer of claim 24, wherein the linking moiety comprises at least one moiety selected from the group consisting of a 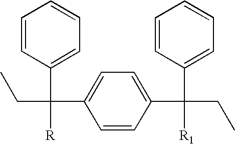
group, a 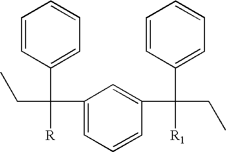
group, and combinations thereof, where R is a branched or unbranched alkyl group containing from 1 to 20 carbons, and where R₁ is a branched, unbranched, or cyclic alkyl group or an aryl group, containing from 1 to 20 carbons.

26. The copolymer of claim 25, wherein R is methyl or ethyl, and R₁ is n-pentyl or 2-methyl-butyl.

27. The copolymer of claim 23, wherein the anionically polymerizable vinylpyridine is 2-vinylpyridine.
